(19) United States
(12) Patent Application Publication
(10) Pub. No.: US 2005/0145089 A1
(43) Pub. Date: Jul. 7, 2005

(54) Handi-guitar (for the handicapped guitar player)

(76) Inventor: Barry Mark Davis, Perkinston, MS (US)

Correspondence Address: BARRY M. DAVIS, 8142 E. LAKE CYPRESS DR., PERKINSTON, MS, 39573, US

(21) Appl. No.: 10/916,575

(22) Filed: Aug. 12, 2004

Related U.S. Application Data
(60) Provisional application No. 60/532,740, filed on Dec. 29, 2003.

(51) Int. Cl. G10D 3/00; H04Q 1/18; G10H 5/00

(52) U.S. Cl. 84/318

(57) ABSTRACT

A thin flat body of clear plastic with a key pad (20) on the inside back base (12), and a chord scale (22) on the outside front of the base (10). The chord scale is fitted with braille nodules (24) for guiding the proper placement of the fingers on the EZ chord. On the bottom or lower side of the base (10) (12) is a gripping angle (14) for the learning chord device. On the top or upper side, and bottom or lower side of the base (10) (12) are gripping angles (14) (16) for the universal chord device. One EZ chord is a device that when manipulated by a human hand, or an artificial hand, is pressed and positioned onto the guitar neck, fret and strings to form and sound guitar chords and/or notes. The EZ chord devices can be used by mentally, physically, or visually handicapped people as well as non-handicapped people, to play and/or learn to play the guitar.

### CROSS-REFERENCE TO RELATED APPLICATIONS

This application claims the benefit of PPA Ser. No. 60/532,740 (APPL NO.), FILING OR 371 DATE Dec. 29, 2003, FILING FEE REC'D 105, CONFIRMATION NO. 4831, ORIGINAL FILING RECEIPT OC000000012264825, UPDATED FILING RECEIPT OC000000012538530. DISCLOSURE DOCUMENT NO. 552077, FILING DATE Apr. 26, 2004. DISCLOSURE DOCUMENT NO. 552581, FILING DATE May 03, 2004. PTO-1652 (August 1999).

### FEDERALLY SPONSORED RESEARCH

Not Applicable

### SEQUENCE LISTING OR PROGRAM

Not Applicable

### BACKGROUND OF THE INVENTION—FIELD OF THE INVENTION

This invention relates to plastic and rubber music chords, specifically to such chords which are used for playing the guitar.

### BACKGROUND OF THE INVENTION

Music and department stores commonly supply consumers with books, paper charts and colored sticker tags for people to study, learn and/or play the guitar. Based on a basic search and a general knowledge of what tools are available, music stores and department stores do not provide learning or playing devices which assist the handicapped guitar player.

Originally learning to play the guitar was accomplished by the use of instruction booklets. For the student, this method has made forming and sounding chords with the fingers difficult, while having to read and study the booklet. As for blind people desiring to learn to play the guitar, some instruction books have been made in braille, but there is no general knowledge of any device which aids blind people with the physical placement of the fingers on the guitar neck. With regard to the above statement, there is no general knowledge of any device which aids the same in sounding chords and notes on the actual guitar strings.

There is no general knowledge of any device that aids people with rheumatoid or other forms of arthritis, gout, or other debilitating diseases of the hands or arms, in playing or learning to play the guitar. With regard to the above statement, there is no general knowledge of any device which aids people with amputated fingers or hands in playing or learning to play the guitar. With regard to the above statement, there is no general knowledge of any device which aids mentally impaired people in playing or learning to play the guitar.

The problem of learning to play the guitar has been partially solved with the use of an instructor, but can be expensive. A major deterrent for anyone who is first attempting to learn to play the guitar has been that of finger blisters and muscle aches on the chord hand. A major advantage of the Handi-Guitar “EZ chord” system of learning to play the guitar is that the whole manner of learning to play the guitar is “reversed”. With the chord device being a means of instantly, accurately and easily placing the chord hand, the student can quickly advance to the procedures of the pick hand. Usually, it would require months or even years before a student of the guitar could reach a level of manipulating the chord hand, before mastering the pick hand. It is this “reverse method” that may keep more people involved in the learning process when many would normally quit trying to play the guitar.

The primary name for the Handi-Guitar device is the “EZ Chord”, but other names could be Magic Chords, Wonder Chords, Perfect Chords, Super Chords, EZ Slide Chords ect.

### BACKGROUND OF INVENTION—OBJECTS AND ADVANTAGES

Accordingly, several objects and advantages of my invention are:
(a) to enable people who are handicapped, specifically those with amputated hands or fingers, or those with arthritis, or other illnesses or injuries of the hands or fingers, to play or learn to play the guitar. Music and/or department stores generally do not offer any such device which aid people in the above area with this disability.
(b) to enable people who are handicapped, specifically those who are sight impaired, to play and/or learn to play the guitar. Other than music books which are made in braille, music and/or department stores generally do not offer any such device that aid people in the above area with this disability.
(c) to enable those with a mental or a learning disability to play and/or learn to play the guitar. Other than music books made for children, music and/or department stores generally do not offer any such device which aid people in the above area with this disability.
(d) to enable non-handicapped people to play and/or learn to play the guitar. The “EZ Chord” system of learning guitar entails a “reverse process” (described above) for playing and/or learning to play the guitar. The “reverse process” eliminates the “old system” (described above) of sustaining finger blisters and/or muscle aches to the chord hand, before attempting to learn the pick hand.

Other objects and advantages are:
(a) EZ chords are prefabricated to strike every string at the precise distance and placement of the desired chord.
(b) EZ chords produce an expert sound the very first time they are properly used, in some cases, better than that of an experienced guitar player.
(c) exact placement of the key pad onto the guitar neck and frets, in some cases, exceeds the normal capability of the human hand.
(d) EZ chords are made of clear plastic with the (actual size) guitar scale laminated on the face of the device. The chord scale on the face of the device is made in braille to guide the guitar player in the exact finger placement of the chord being utilized. Based on a general search and a basic knowledge of music and department stores, the only chord and finger scales offered to the consumer are paper charts and books.

Further objects and advantages of my invention will become apparent from a consideration of the drawings and ensuing description.

### SUMMARY

In accordance with the present invention a Handi-Guitar, “EZ Chord” is a thin flat body of clear plastic with a rubber key pad on the inside back. The inside back is defined as the side that makes contact with the guitar strings. On the outside front is a (actual size) chord scale with braille nodules that mark the exact placement of the fingers on the chord hand. The outside front is defined as the side that makes contact with the human or artificial hand and fingers. At the bottom of the base is a slightly beveled gripping angle for the learning chords. At the top and bottom of the base are slightly beveled gripping angles for the universal chords. The top and bottom of the base of the EZ chord device is defined as the upper and lower side of the guitar chord scale as shown on any standard guitar chart. Just the same, the top and bottom of the EZ chord device is defined as the upper and lower side of the chord scale (actual size) as shown on the chord device itself.

One EZ chord is a device that when manipulated by a human hand, or an artificial hand, is pressed and positioned onto a guitar neck, fret and strings to form and sound guitar chords and/or notes.

### DRAWINGS—FIGURES

FIG. 1A to 1C is a perspective geometric outside front and side view, inside back and side view, and side view of the “EZ chord” learning chord device, adjustable lock-screw type.

FIGS. 1D and 1E is a perspective geometric outside front and side view, and inside back and side view of the “EZ chord” learning chord device with the guitar chord scale and braille nodules laminated on the outside front of the base.

FIG. 2A to 2C is a perspective geometric outside front and side view, inside back and side view, and side view of the “EZ chord” universal chord device, adjustable grip type.

FIGS. 2D and 2E is a perspective geometric outside front and side view, and inside back and side view of the “EZ chord” universal chord device, with the guitar chord scale and braille nodules laminated on the outside front of the base.

FIG. 3A is a perspective geometric view of the “EZ chord” learning chord device (dissected), adjustable lock-screw type.

FIG. 4A is a perspective geometric view of the “EZ chord” universal chord device (dissected), adjustable grip type.

FIG. 5A to 5C is a perspective geometric outside front and side view, inside back and side view, and side view of the “EZ chord” universal chord device, adjustable lock-screw type.

FIG. 6A is a perspective geometric outside front and side view of the “EZ chord” universal chord device, dial-a-chord type.

FIG. 7A is a perspective geometric outside front and side view of the “EZ chord” learning chord device, hinge type.

FIG. 8A is an example of the proper placement of the “EZ chord” learning chord device, onto the guitar neck, frets and strings.

FIG. 9A is an example of the proper placement of the “EZ chord” universal chord device, onto the guitar neck, frets and strings.

### DRAWING—REFERENCE NUMBERS

10 outside front base
12 inside back base
14 bottom-lower gripping angle
16 top-upper gripping angle
18 keys
20 key pad
22 chord scale
24 braille nodules
26 guitar neck
28 guitar fret
30 guitar strings
32 screw
34 nut
36 slide grove for dial-a-chord
38 hinge
40 EZ chord

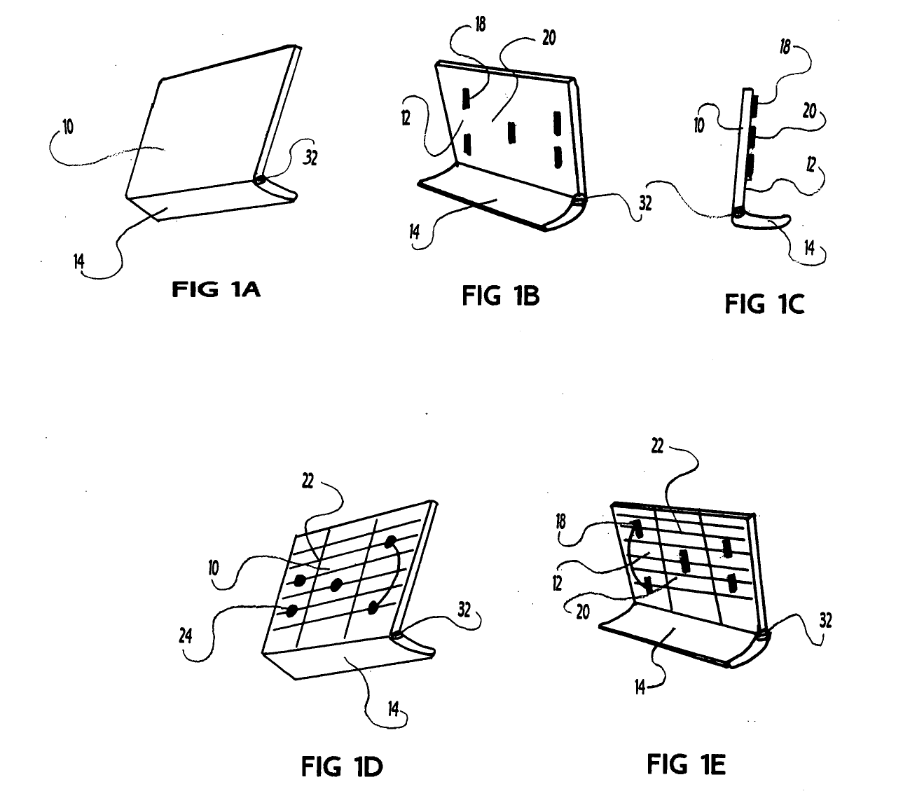

### DETAILED DESCRIPTION—FIGS. 1A TO 4A—PREFERRED EMBODIMENT

A preferred embodiment of the Handi-Guitar “EZ chord” learning chord device of the present invention is illustrated in FIG. 1A (outside front and side view), FIG. 1B (inside back and side view), FIG. 1C (side view), FIG. 1D (outside front and side view) with the chord scale laminated on the base, and FIG. 1E (inside back and side view) with the chord scale laminated on the base.

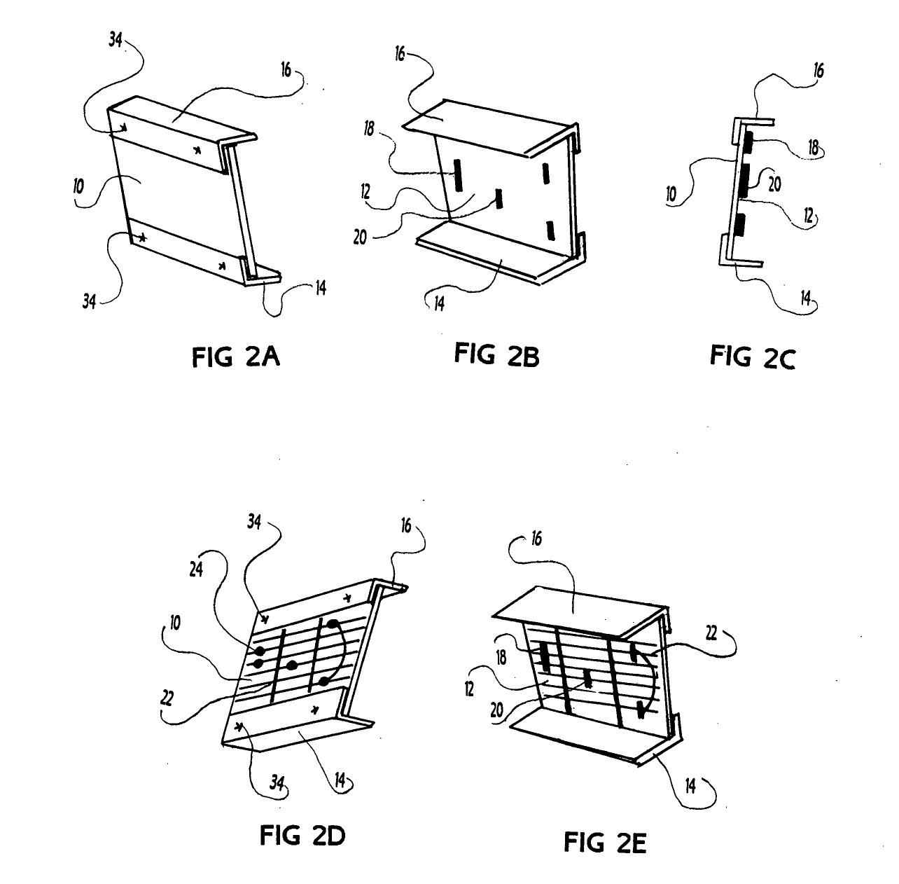

A preferred embodiment of the Handi-Guitar “EZ chord” universal chord device of the present invention is illustrated in FIG. 2A (outside front and side view), FIG. 2B (inside back and side view), FIG. 2C (side view), FIG. 2D (outside front and side view) with the chord scale laminated on the base, and FIG. 2E (inside back and side view) with the chord scale laminated on the base.

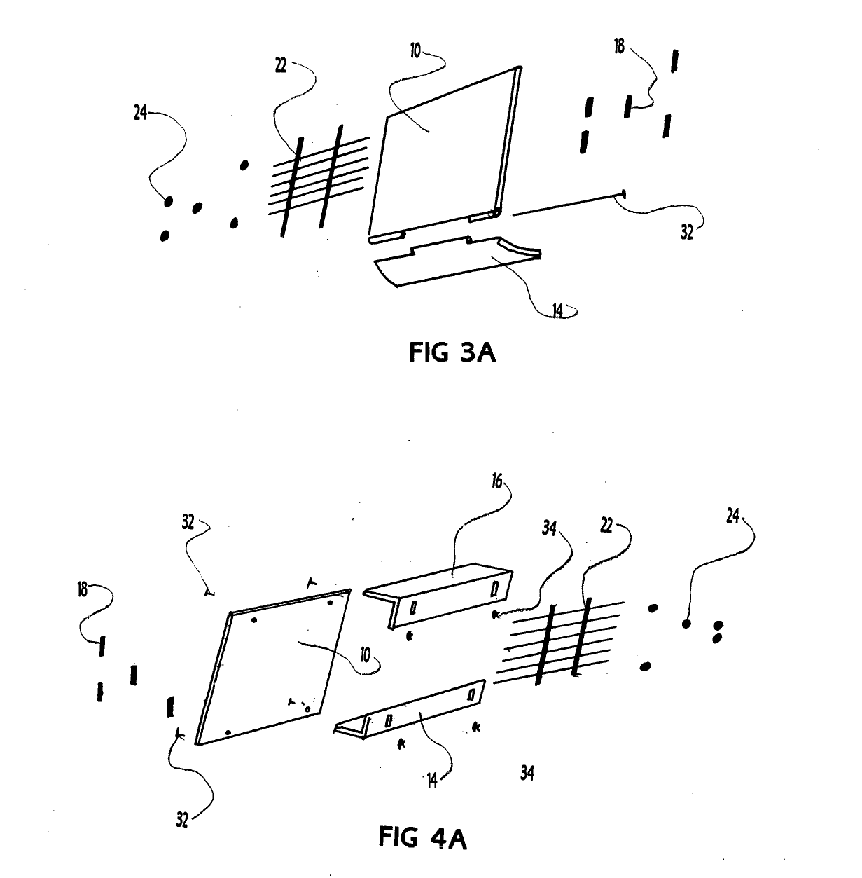

A preferred embodiment of the Handi-Guitar “EZ chord” learning chord device of the present invention is illustrated in FIG. 3A (dissected view), adjustable lock-screw type.

A preferred embodiment of the Handi-Guitar “EZ chord” universal chord device of the present invention is illustrated in FIG. 4A (dissected view), adjustable grip type.

The Handi-Guitar, EZ Chord has a thin base 10, 12 of square or rectangular shaped hard material which does not bend. At the bottom of the base 10, 12 is a slightly beveled gripping angle 14 for the learning chord. At the top and bottom of the base 10, 12 are slightly beveled gripping angles 14, 16 for the universal chord. Gripping angles are made adjustable by screws 32 and nuts 34.

For the preferred embodiment the base is made of clear plastic such as plexy glass, but may be comprised of wood, metal, rubber, fiber glass, vinyl, cement, epoxy, felt, polyurethane, polypropylene, polyethylene, varnish, nylon, leather, various glued fibrous materials, cardboard, paper, various plasticized materials, various metallic materials, various rubberized materials, or many other substances which can be fabricated or formed into the said chord device.

The body of the EZ chord is a square or rectangular shape but may consist of various shapes such as a circle, triangle, hectagon, pentagon, octagon, or various other sizes and shapes such as a glove type with finger holes, or may come with or without a strap.

On the inside back of the base 12 are keys 18 that form a key pad 20. On the preferred embodiment the keys are comprised of silicone rubber, but may be made of various plasticized materials, cardboard, felt, paper, laminated materials, glued materials, vinyl, epoxy, rubberized and metallic materials ect.

On the outside front of the base 10 is a chord scale 22. On the preferred embodiment the chord scale is a clear thin laminated (sticker) with dark lines depicting the (actual size) guitar scale. The chord scale duplicates that of the same scale on any instruction chart, and is the same size as the guitar neck, fret and strings. The chord scale may be painted, drawn, etched, carved, pasted, glued, laminated, or depicted in various ways and forms on the outside, inside, or sandwiched in the center of the base.

On the chord scale are braille nodules 24 which serve as a reference guide for the proper placement of fingers onto the EZ chord. Braille nodules 24 are flat and round on one side, and mounded or protruded on the opposite side, and are about the same size as a human finger tip. The nodules are made of silicone rubber but may consist of various rubberized materials, various plasticized materials, various metallic materials, vinyl, epoxy, fiber glass, varnish, nylon, wood, paper, glued materials, ect.

The base 10, 12 of the Handi-Guitar, EZ chord device is typically 1/16 to ¼ inch thickness and has overall dimensions roughly 2″×2″ (square shaped) to 2″×3″ (rectangle shaped) for larger chords, and 1¾″×1¾″ (square shaped) to 1½″×1¾″ (rectangle shaped) for smaller chords. Smaller chords are generally made for children's guitars. However, the EZ chord devices may vary is sizes and/or shapes. The outer corners of the base 10, 12 and gripping angles 14, 16 are typically rounded and beveled to avoid snagging and/or personal injury. Also, when the Handi-Guitar, EZ chord device is held firmly against the bottom or top of the guitar neck, the slightly beveled and rounded gripping angles provide a “rolling motion” as the chord device is pulled away and repositioned in repetition with the music notes being played.

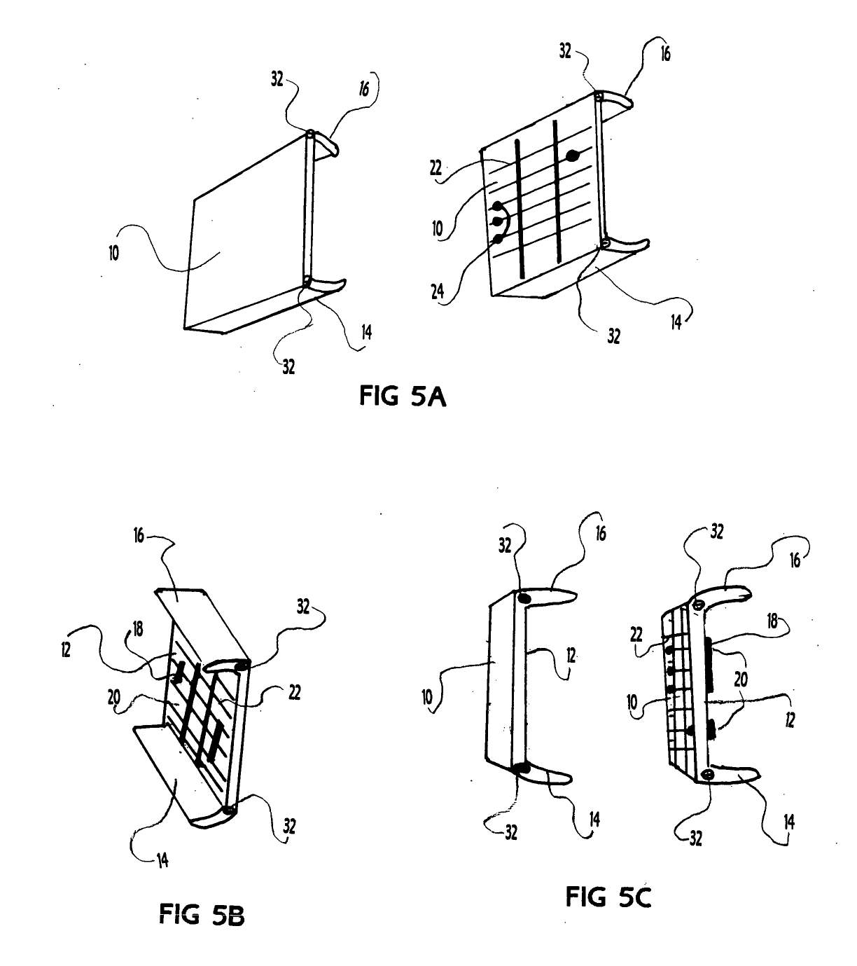

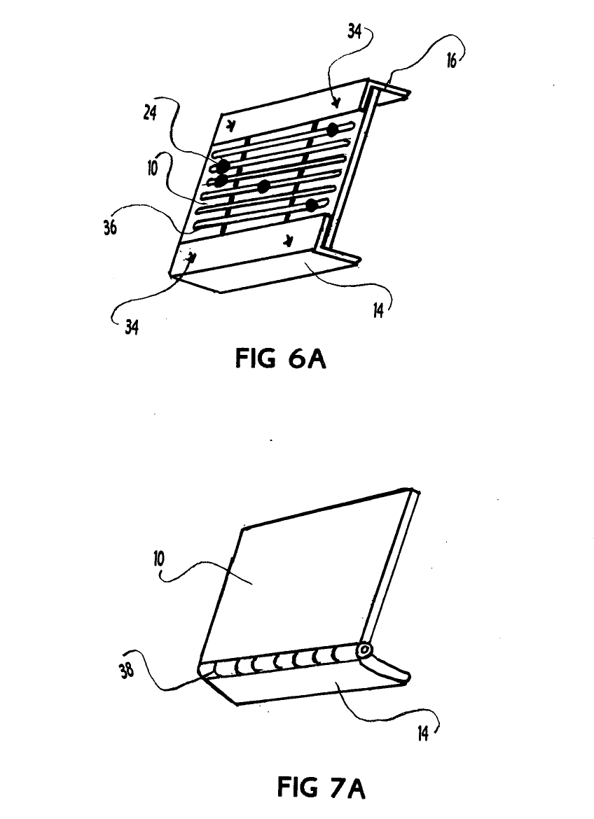

### FIGS. 5A to 5C, and 6A—Additional Embodiments

Additional embodiments of the Handi-Guitar, “EZ chord” universal chord device of the present invention is illustrated in FIG. 5A (outside front and side view), 5B (inside back and side view), FIG. 5C (side view) of the adjustable lock-screw type, and FIG. 6A (outside front and side view) of the dial-a-chord, adjustable grip type.

### FIG. 7A—Alternative Embodiments

Alternative embodiments of the Handi-Guitar, “EZ chord” learning chord device of the present invention is illustrated in FIG. 7A (outside front and side view) of the hinge type device. Other alternative embodiments may have various possibilities with regard to the relative disposition of shape, dimensions, and gripping points, as well as various colors or non-colors. Further embodiments may include various adjustable or fixed gripping points. A precisely engineered “EZ chord” device may appear exactly like the preferred embodiments with an exception being that of permanent or fixed gripping angles.

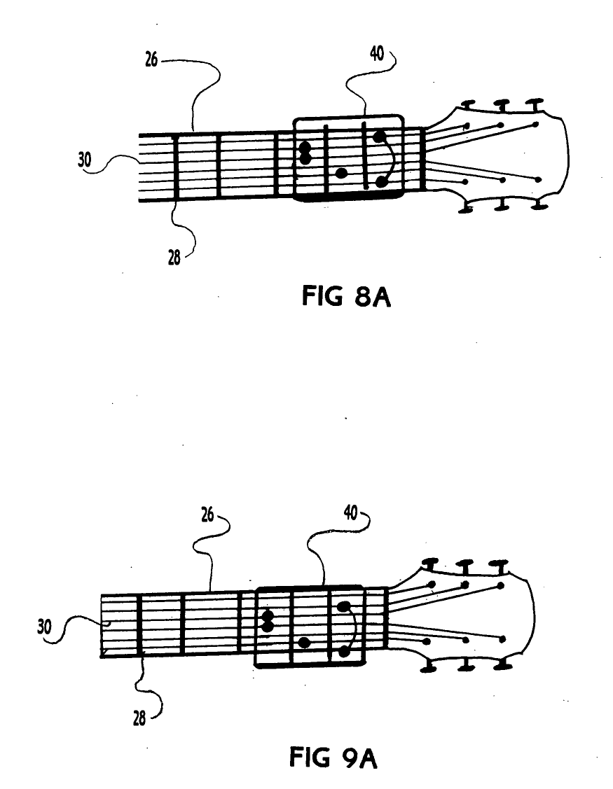

### Operation—FIGS. 8A and 9A

The manner of using the Handi-Guitar “EZ chords” are identical to the points of finger placement on the guitar neck, fret and strings, for any desired chord (without the plastic invention device). Namely, to play the “F Major chord” on the first, second and third frets on any guitar neck, the EZ chord 40 (FIG. 8A, learning chord device) with the “F” configuration is selected from the “chord group”. While holding the outside front of the base 10 in the palm of the hand, and placing the fingers on the braille nodules 24, the chord is sounded into a note by holding the bottom gripping angle 14 to the bottom of the guitar neck 26, and pressing the inside back base 12 and the key pad 20 to the frets 28 and the strings 30.

In the same fashion as above, to play the “B Minor chord” on the same first, second and third frets as named above, the EZ chord 40 (FIG. 9A, universal chord device) with the “F” configuration is selected from the “chord group”. To sound the “B Minor” chord into a note, follow the same procedures as above with the exception that the top gripping angle 16 is held against the top of the guitar neck 26. The universal chord in FIG. 9A, when manipulated in a vertical fashion and on the same frets as the learning chord in FIG. 8A, can perform the function of both chords. Learning chords are for the purpose of teaching guitar chords to people who are unfamiliar with the guitar. Universal chords form a multi-function of chords on the chord scale, and may be used both by beginners and experienced guitar players. EZ chord devices of every chord may be used in the same manner as above depending on the type of chord used (learning, or universal). The “F” chord is used as an example above because it is the most common and the most difficult to manipulate. Depending on the chord device being used, once the guitar player has properly placed the EZ chord onto the guitar neck 26 and strings 30, it may be manipulated vertically, parallel or horizontally along, and/or between the guitar frets as a means for producing a range of guitar chords and notes. The procedures stated above are the same for all guitar chords on any scale including 6-string guitars, 12-string guitars, 5-string guitars, bass guitars, and various other guitar type instruments.

### CONCLUSION, RAMIFICATIONS, AND SCOPE

Accordingly, the reader will see that the Handi-Guitar, EZ chords can be used by mentally, physically, and visually handicapped people easily and conveniently, to play or learn to play the guitar. In addition, the EZ chords can be used by non-handicapped people of all ages to learn and play the guitar in a timely and much simplified fashion. The quality of sound combined with the ease of using the chord devices far exceeds the conventional way of reading books and charts to learn to play the guitar. The advantage of the chord devices to certain handicapped people is priceless in a sense that there is no common or general knowledge of any devices made for blind, amputee, or people with joint diseases, or mentally impaired people, to play or learn to play the guitar. Furthermore, the EZ chord “reverse” system of teaching children to play the guitar will no doubt create a much wider audience of guitar playing adults in the future.

Although the description above contains many specifications, these should not be construed as limiting the scope of the invention but as merely providing illustrations of some of the presently preferred embodiments of this invention. For example the EZ chord devices can have other shapes, such as circular, oval, trapezoidal, triangular, ect.

The base and gripping angles can have various other shapes. Gripping angles can be fixed, adjustable, or fitted with hinges, tracks, ect.

The guitar itself can be fitted with fixed hinges, tracks, and/or devices which perform the same function as the base of this invention. The function of the EZ chord device can be duplicated by means of electronic devices. Such devices are the “electronic collar” and the “electronic neck” as described in detail in the PPA for this invention.

Thus, the scope of the invention should be determined by the appended claims and their legal equivalents, rather than by the examples given.

1. A guitar chord device of the type comprising a flat body of material. At the bottom of the base thereof is a gripping aperture (for the learning chord device).

2. A guitar chord device of claim 1 wherein the top and bottom of the base thereof are gripping apertures (for the universal chord device). The top and bottom of the base of the said chord device is defined as the upper and lower side respectively, of any chord scale as depicted on any standard guitar chord chart. The top and bottom of the base of the said chord device is defined as the upper and lower side respectively, of the chord scale (actual size) as depicted on the chord device itself.

3. A guitar chord device of claim 1 wherein the said body may be comprised of plastic, wood, metal, rubber, fiber glass, vinyl, cement, epoxy, felt, polyurethane, polypropylene, polyethylene, varnish, nylon, leather, various glued substances, fibrous materials, cardboard, paper, various plasticized materials, various metallic materials, various rubberized materials, or various other substances which can be formed and fabricated into the said chord device.

4. A guitar chord device of claim 1 wherein the said body or any other part of the device may be any color, or multiple colors, or plain (no chord scale), or no color, clear, ect.

5. A guitar chord device of claim 1 wherein the said body is elongate with gripping apertures on the top and bottom of the base respectively. The said gripping apertures are measured to grip the top or bottom of the guitar neck during the operation of the said chord device.

6. A guitar chord device of claim 1 wherein the said gripping apertures are fabricated to be fixed or adjustable to various guitar neck sizes as well as various guitar brands.

7. A guitar chord device of claim 1 wherein the said body and gripping apertures may consist of various shapes such as a circle, square, rectangle, triangle, hectagon, pentagon, octagon, or various different sizes. The said guitar chord device can be fabricated to duplicated the human hand about which finger holes may be provided in the same fashion as a glove. The said chord device may be utilized with or without a strap.

8. A guitar chord device of claim 1 wherein the said gripping apertures may be positioned and/or fixed onto the guitar neck by means of angles, hooks, hinges, tracks, snaps, straps, rails, or various possibilities with regard to the relative disposition of shape, dimensions, and/or gripping points, or other means of properly placing the said base onto the guitar neck, fret and strings.

9. A guitar chord device of claim 1 wherein the said body is comprised of a clear material thereby sandwiching the (actual size) guitar chord scale between a key pad on one side, and braille nodules on the opposite side respectively.

10. A guitar chord device of claim 1 wherein the inside back of the said base are keys that form a key pad. The inside back is defined as that side which makes contact with the guitar strings.

11. A guitar chord device of claim 1 wherein the key pad are keys that may form any chord configuration on the guitar chord chart, and may be placed in any position or various positions on the base. The keys are a thin rubberized or felt material that are fabricated to strike the guitar strings in the same manner as the human finger tip.

12. A guitar chord device of claim 1 wherein the said keys may consist of various materials such as silicone rubber, various plasticized materials, various rubberized materials, various metallic materials, cardboard, felt, paper, laminated materials, glued materials, vinyl, epoxy, ect.

13. A guitar chord device of claim 1 wherein the said keys or key pad are movable, so as to create any chord on the guitar chord scale, from one chord device.

14. A guitar chord device of claim 1 wherein the outside front of the said base is a clear thin decal with dark lines depicting the actual size guitar chord scale. The said chord device can be made to duplicate any scale on the guitar chord chart. The outside front is defined as that side which makes contact with the human hand, or the artificial hand, and/or the fingers. The said chord scale on the said base is the actual dimensions of the guitar neck, fret and strings.

15. A guitar chord device of claim 1 wherein the said chord scale may be painted, drawn, etched, carved, pasted, glued, laminated, or depicted in various ways and forms. The said chord scale may be illustrated on the said outside front of the said base, the inside back of the said base, or sandwiched in the center of the said base.

16. A guitar chord device of claim 1 wherein the said chord scale on the said base is marked with braille nodules for finger placement onto the said chord device. The braille nodules are mounded, protruded, or hollow for exact placement of fingers onto the chord device. The said braille nodules are about the size of the tip of the human finger or slightly larger if made with finger holes.

17. A guitar chord device of claim 1 wherein the braille nodules may be comprised of silicone rubber, various rubberized materials, various plasticized materials, various metallic materials, vinyl, epoxy, fiber glass, varnish, nylon, wood, paper, glued substances, or various sizes, ect.

18. A method of utilizing the said (EZ chord) guitar chord device to play the guitar, comprising:
(a) Providing a guitar chord device of claim 1 wherein the type comprising a flat body having gripping angles on the top and bottom of the base, and communicating with said base for precise placement of said chord device onto the guitar neck, frets and strings.
(b) Providing a guitar chord device of claim 1 wherein the type comprising a flat body of material having a key pad, braille nodules, and a (actual size) chord scale that can be made into any desired chord on the base thereof.
(c) Providing a guitar chord device of claim 1 wherein the manner of utilizing the said “EZ chord” is identical to the points of finger placement on the guitar neck, frets and strings of the desired chord.
(d) Providing a guitar chord device of claim 1 wherein the chord scale and the braille nodules serve to guide the guitar player in the precise placement of the fingers onto the chord device.
(e) Providing a guitar chord device of claim 1 wherein the said learning chord is utilized by holding the said bottom gripping aperture onto the said bottom of the guitar neck, as a means for placing the chord device at the proper guitar frets and strings.
(f) Providing a guitar chord device of claim 1 wherein the said universal chord device is utilized by holding the said top or bottom gripping angle onto the top or bottom of the guitar neck respectively, as a means for placing the said guitar chord device at the proper frets and strings.
(g) Providing a guitar chord device of claim 1 wherein a guitar chord is sounded into a guitar note by pressing the said inside back of the base and the said key pad onto the desired guitar frets and strings respectively.
(h) Once the guitar player has properly placed the said learning chord device of claim 1 onto the said guitar neck, frets and strings, the said chord may be manipulated parallel or horizontally along or between the guitar frets and strings for producing a range of guitar chords and notes.
(i) Once the guitar player has properly placed the said universal chord device of claim 1 onto the said guitar neck, frets and strings, the said chord device may be manipulated vertically, parallel or horizontally along and/or between the guitar frets and strings as a means for producing a range of guitar chords and notes.

19. Providing the said guitar chord device of claim 1 as a means for handicapped as well as non-handicapped people to play and/or learn to play all types of guitars including acoustic guitars, electric guitars, 6-string guitars, 12-string guitars, 5-string guitars, 4-strings guitars, bass guitars and various other guitar type instruments.

20. Providing a guitar chord device of claim 1 for mentally, physically, or visually impaired people who desire to learn and/or play the guitar. The said chord device is manipulated by a biological or artificial hand as a means for playing, forming, or sounding chords or notes indicium to that of a guitar instrument.
